(19) United States
(12) Patent Application Publication
(10) Pub. No.: US 2014/0129459 A1
(43) Pub. Date: May 8, 2014

(54) METHOD AND SYSTEM FOR SOCIAL MEDIA INTEGRATION INTO BUSINESS APPLICATIONS

(71) Applicants: Niklas Baudy, Boehl-Iggelheim (DE); Julian Gimbel, Driedorf-Waldaubach (DE); Daniel Jakobs, Ettingen - Bruchhausen (DE); Jonas Sladek, Heiligkreuzsteinach (DE); Julian Breunung, Mannheim (DE); Stefanie Rupp, Mannheim (DE)

(72) Inventors: Niklas Baudy, Boehl-Iggelheim (DE); Julian Gimbel, Driedorf-Waldaubach (DE); Daniel Jakobs, Ettingen - Bruchhausen (DE); Jonas Sladek, Heiligkreuzsteinach (DE); Julian Breunung, Mannheim (DE); Stefanie Rupp, Mannheim (DE)

(21) Appl. No.: 13/670,079

(22) Filed: Nov. 6, 2012

(51) Int. Cl. G06Q 99/00

(52) U.S. Cl. 705/319

(57) ABSTRACT

A method and system to receive business data related to an entity from a business application; determine at least one social media network to access by the business application; query the at least one social media network, based on search criteria derived from the business data, for unique identifiers of the at least one social media network associated with the entity; and determine a true identifier of the entity for the at least one social media network based on the unique identifiers and the business data.

### FIELD

Some embodiments relate to social media networks. In particular, some embodiments concern methods and systems for integrating business applications and services with a variety of social media networks.

### BACKGROUND

Social media networks may provide a mechanism for entities, including individuals, businesses, organizations, and groupings thereof, to create, consume, and share content. Depending on the social media network, the content may include a variety of media types, including structured and unstructured text documents, graphics, video, audio, and combinations including the same. The content may typically be generated by the users of the social media networks. In some regards, a social media network user can share personal information about themselves via the social media network. The depth and breadth of the user-related information shared on a social media network may vary depending of the user's willingness to share personal information and/or constraints of a given social media network. Insight about an entity may be gained by, for example, analyzing the entity's social media network postings.

In some regards, the level of communication between entities can be enhanced through the use of social media networks. For example, customer-client relations may be enhanced and deepened by interactive exchanges between the customer and the client that are users of the same social media network. However, while relationships may be made and/or strengthened on social media networks by exchanges between different users thereof, it is critically important that the “right” or correct social media network users connect with each other. For example, a company having the real-world name of “Acme Corporation” may be assigned the username of “AcmeCo” on a first social media network and the username of “Acme_Corp” on a second social media network. Hence, it is important that a user of the first and/or second social media networks wishing to connect with the company accurately know the identity of the “Acme Corporation” on each respective social media network. Additionally, the increasing number and variety of social media networks may further complicate the ability of a user to accurately communicate with others on a social media network.

### BRIEF DESCRIPTION OF THE DRAWINGS

FIG. 1 is a representative block diagram of a system, according to some embodiments.

FIG. 2 is an illustrative depiction of some aspects herein, according to some embodiments.

FIG. 3 is a flow diagram of a process, according to some embodiments herein.

FIG. 4 is an illustrative depiction of some aspects herein, according to some embodiments.

FIG. 5 is an illustrative depiction of some aspects herein, according to some embodiments.

FIG. 6 is a block diagram of a system, in accordance with some embodiments herein.

### DETAILED DESCRIPTION

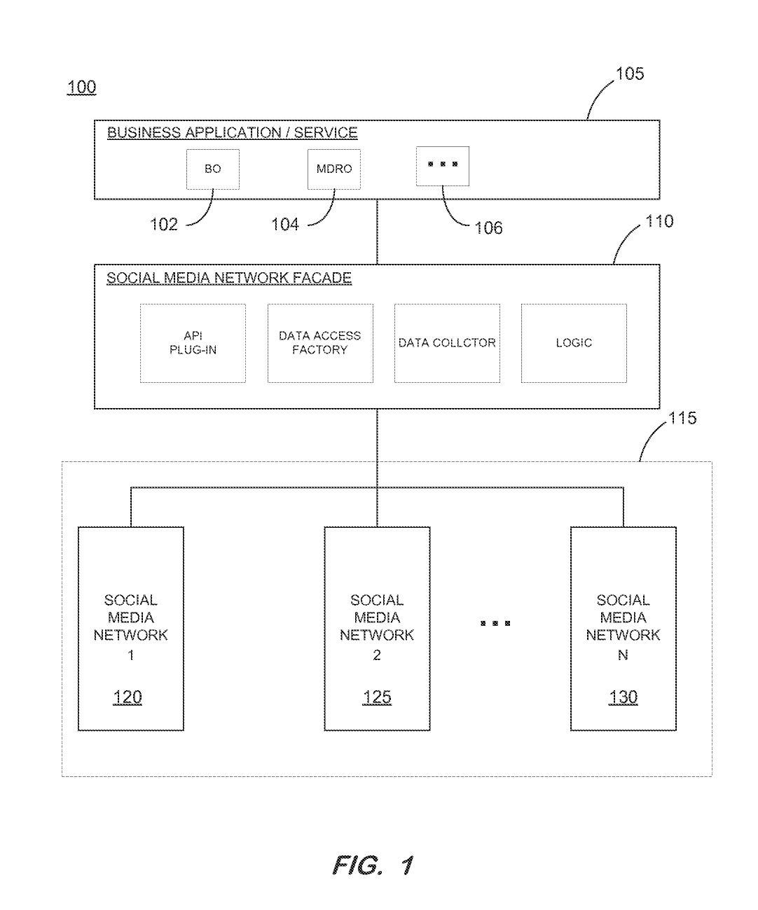

FIG. 1 is an illustrative block diagram of a system, generally depicted at 100, that supports the integration of a business application with one or more social media networks. The business application may be implemented as or part of a business service provided by a service provider. The service provider may be a business organization. As used herein, a social media network may include any system, service, or platform that supports an exchange of media content between entities, individuals, groups, and others, using any type or form of technology. The social media networks herein may comprise internet-based forums, social networks, blogs, microblogs, bookmarking sites (e.g., focused on a specific medium (pictures, videos, etc.) and/or subjects (technology, fashion, food, etc.), and other techniques).

System 100 includes a business application 105. Business application 105 may be any business software application used by an organization or business to facilitate the function(s) of the business or other organization. Business application 105 is not limited herein to supporting a specific business function or capacity. In some regards, business application 105 may be implemented as a service running on one or more technology configurations, including distributed computing environments, software as a service, and cloud hosted environments. In some aspects, business application 105 may viewed as a user of a business application and social media network integration “framework” that will be disclosed in greater detail below.

In some aspects, business application 105 (and users thereof such as, for example, managers, administrators, and developers) may have a relationship with another entity. As an example, business application 105 may include a customer relationship management (CRM) application that manages a company's interactions with customers, clients, and sales prospects. The CRM application may technically organize, automate, and synchronize numerous business processes. In the course of executing its processes and functions as a CRM application, business application 105 may typically possess some business data or information regarding its customers, clients, and sales prospects.

In some aspects, business application 105 (and users thereof) may desire or have a need to enhance the relationship between the business application and its customers, clients, and sales prospects. In this regard, business application 105 may seek to communicate with its customers, clients, and sales prospects (and others) via one or more social media networks of which its customers, clients, and sales prospects are member users.

In some aspects, business application 105 may include a platform, service, or software system. In some embodiments, business application 105 may include a plurality and combination of software, hardware, and firmware components. Such components may include, for example, a business object (BO) 102, a MDRO 104, and any other technical control or data construct 106 comprising business application 105 that may make a call social media facade 110 in an effort to communicate with social media networks 115.

In some aspects, business application 105 may, as a function of performing the operations and processes thereof, obtain, generate, determine, or otherwise possess business data related to its customers, clients, prospects, and others. In some respects, the business data is information associated with its customers, clients, prospects, and others that is known to business application 105.

As used herein, a social media network member user or simply user is an entity “registered” or otherwise affiliated with a social media network. The “registration” of a user with a given social media network typically involves the user being assigned an identifier for that particular social media network. The social media network identifier may uniquely identify a specific user or group of users from other users of the same social media network. The user may generally be referenced by and associated with their social media network identifier when logged onto the social media network, exchanging content on the social media network, and otherwise interacting with the social media network. As such, content (i.e., data) shared by the user on the social media network is generally linked to or otherwise associated with the user's social media network identifier that is unique for that particular social media network.

In some instances, a user may be a member user of a plurality of social media networks. In some instances (and for a variety of reasons) the user's social media network identifier may not be the same across all of the social media networks to which the user belongs. In some instances, a user's identity on even one social media network may differ from that entity's real-world name or other identifier (e.g., stock exchange listing symbol, etc.). Accordingly, a lack of and/or potential lack of consistency regarding an entity's identity on social media network(s) may be considered, addressed, or otherwise accounted for by a business before that business communicates or otherwise attempts to interact with a customer, client, sales prospect, and others via a social media network.

Referring to FIG. 1, social media facade 110 provides a mechanism for business application 105 to interface with one or more social media networks 115. Business application 105 may interface with one or more of the social media networks 115 in order to, for example, collect social media data that is associated with its customers, clients, and sales prospects from the social media networks. In part, social media facade 110 provides the technical and logical connections needed to accommodate communication between business application 105 and social media networks 115.

In some embodiments, social media networks 115 may include a variety of social media networks, where each social media network 120, 125, and 130 may accommodate the exchange of different types of content, including a variety of media types, including text, graphics, video, audio, and combinations thereof and be implemented using a wide range of different technology configurations and communication protocols. As such, social media facade 110 may include specific components required to interface with the specific social media networks 115. In some embodiments, social media facade 110 may include components and mechanisms individualized, at least in part, for interfacing with the specific social media networks 120, 125, and 130. For example, a different application programming interface (API) may be required for each of the social media networks shown at 115 of FIG. 1. An API may specify the interface used by software components to communicate with each other. API's and other social media network components may be used to define a plug-in for each of the social media networks 120, 125, and 130. In some embodiments, a plug-in may refer to a software data structure that is instantiated to facilitate communicating between business application 105 and the one or more social media networks 120, 125, and 130 to, for example, collect social media data associated with its customers, clients, sales prospects, and others from the social media networks. In some aspects, social media facade 110 may support communication and interfacing with any and all social media networks, including those currently known and those that become known in the future.

In some aspects, social media fasade 110 may function to receive a call to communicate with at least one of social media networks 115 and delegate the call to specific plug-ins (or other mechanisms) for the specific social media network(s) relevant to the call. In some aspects, the call may be initiated or at least related to a request to determine a “true”, correct, or at least a best match, identifier associated with an entity for the specific social media network(s).

In some embodiments, social media facade 110 may receive, from business application 105, business data associated with an entity and known to the business application in a request to determine a “true” identity of the entity on one or more social media networks 115. In some aspects, social media facade 110 may provide the appropriate interface(s) required to effectively communicate with the social media networks.

In some embodiments, social media facade 110 may operate to determine which social media networks 120, 125, and 130 should be queried to respond to a request for an entity's “true” social media network identity for one or more social media networks. For example, in an instance that business application 105 and/or users thereof are permitted to only communicate with social media networks 120 (e.g., Facebook) and 130 (e.g., Twitter), then social media facade 110 may determine that it need only facilitate communication with social media networks 120 and 130, and not social media network(s) 130. The social media networks to be accessed by social media facade 110 may be determined based on an analysis of different data by social media facade 110 and/or an indication of the relevant social media networks. The indication of the relevant social media networks, if any, may be provided by business application 105 and/or users thereof.

In some aspects, social media facade 110 and the components thereof may operate to query the appropriate social media networks 115 to respond to a request for an entity's “true” identity on one or more of the social media networks. The query of the social media networks 115 may be accomplished using the business data associated with the entity, which is known to business application 105 and may be received in the request for the entity's “true” identity on the one or more social media networks. The query of the social media networks 115 for an entity's “true” identity on the one or more of the social media networks may result in the return of one or more identifiers from the queried social media networks 115. The set of identifiers resulting from the query of the social media networks may be analyzed by social media facade 110 to determine the “true” identity of the business application related entity for each of the queried social media networks 115. In some embodiments, a combination of the business data from business application 105 associated with the entity and the social media network data resulting from the query of the social media networks may be analyzed by social media facade 110 to determine the “true” identity of the business application known entity for each of the queried social media networks 115.

In some embodiments, social media facade 110 may use various types of data structures and instantiations thereof to implement the functionality and processes disclosed herein. In some embodiments, social media facade 110 may comprise, for example, one or more object oriented programming language objects.

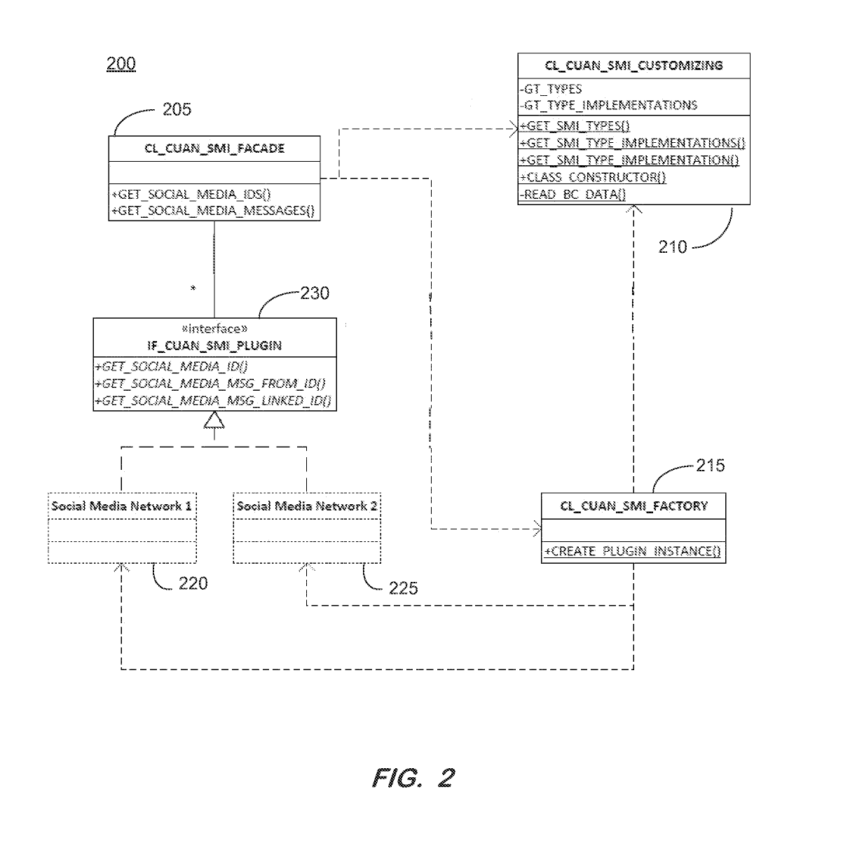

FIG. 2 is an illustrative depiction of some aspects herein. In particular, FIG. 2 is a representative view of a framework 200 that supports processes and systems disclosed herein that integrate a business application with aspects of social media networks. In some aspects, framework 200 may include a number of classes 205-230 that represent abstractions of object oriented programming language objects. In some embodiments, the objects may be ABAP (Advanced Business Application Programming) Objects whose attributes, states, and behaviors are defined and described by the class(es). In some aspects, framework 200 may correspond to aspects of social media facade 110 of FIG. 1.

Regarding FIG. 2, facade class 205 may define a base or default social media facade. In some embodiments facade class 205 may include specifications for some core functions for providing processes herein, including interfacing with one or more social media networks. A business application or service such as that described in connection with FIG. 1 may communicate with an instance of facade class 205. The social media facade represented by framework 200 may be customized to access one or more specific social media networks. Customization class 210 may provide the specifications and descriptions for the particular social media networks to be accessed by a business application via the social media facade. In some embodiments, a business application or user thereof may activate/deactivate and otherwise provide an indication of a social media network to be accessed by the social media facade on behalf or at the request of the business application. Customization class 210 may operate to customize the framework to accommodate one or more specific social media networks that may be relevant to a particular business application (e.g., business application 105, FIG. 1).

Instances of plug-ins and other components to interface with the social media networks as specified by facade class 205 and customization class 210 may be generated in accordance with plug-in factory class 215. Plug-in factory class 215 may provide specifications to create plug-ins for, as an example, a first social media network plug-in 220 and a second social media network plug-in 225. Plug-ins for the first social media network 220 and the second social media network 225 may be used by interface plug-in class 230 to connect to the first and second social media networks, respectively. In some aspects, interface class 230 and the plug-ins associated therewith may be instantiated during a runtime.

In some embodiments, the plug-ins for the first social media network 220 and the second social media network 225 may be used by interface plug-in class 230 to, for example, retrieve social media network data and determine a “true” identifier (i.e., an I.D.) for a business entity associated with business data of the business application. The determined “true” identifier may be output to, provided to, and otherwise presented to the business application through the social media facade provided in accordance with the specifications of facade class 205. In some instances, a “true” identifier may be presented to the business application for each of the social media networks.

In some aspects, upon determination of the “true” identity of the business entity associated with the business data of each of the social media networks, the “true” identity may be provided to facade class 205 for reporting, storing, or further processing by the business application that communicates with the facade class 205.

In some embodiments, instantiations of facade class 205 and interface plug-in class 230 may further operate to request social media network data from the social media networks (e.g., social media networks 220 and 225) related to the entity corresponding to the “true” identifier for each of the social media networks. Such social media network data may include, for example, social media messages related to the determined the “true” identifier on the social media networks, request social media messages linked to the “true” identifier on the social media networks, and other aspects not specifically depicted in FIG. 2.

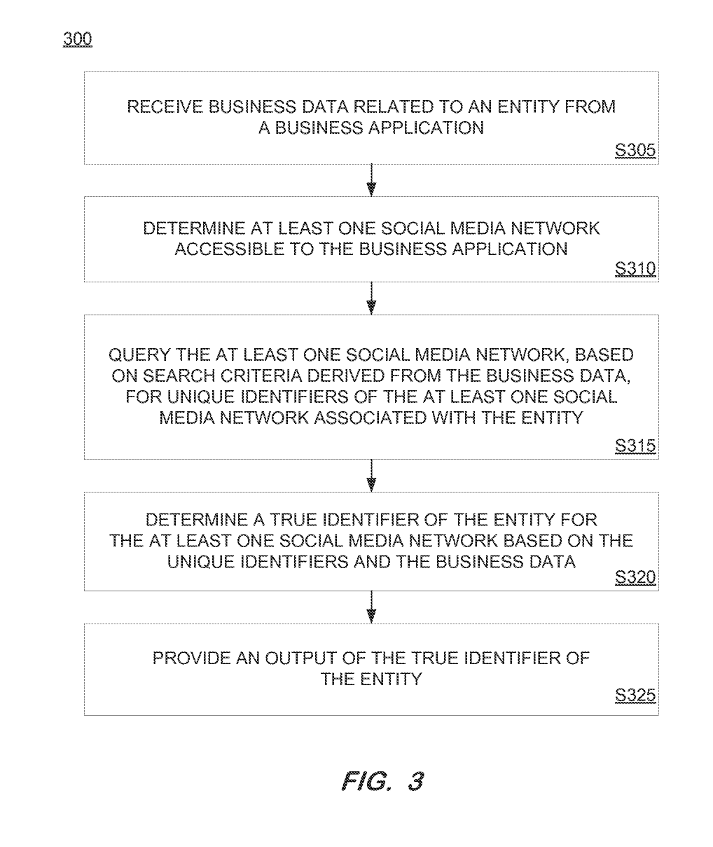

FIG. 3 is a flow diagram of a process 300, according to some embodiments herein. Process 300 may, in some aspects, relate to the system of FIG. 1 and the framework of FIG. 2. In some aspects, process 300 may relate to systems and frameworks including more, fewer, and components alternative to those depicted in FIGS. 1 and 2. At S305, the process receives business data related to an entity from a business application. In some aspects, the business application may be a software programmed application that has some business data associated therewith. The business data may include, for example, information related to entities associated with the business application. Such information may include a (real world) name of the entity, a postal address for the entity, a URL corresponding to the entity, and other information known by the business application and associated or connected with the entity. In some aspects, the business data associated with the entity may be obtained, determined, generated, and otherwise become known to the business application as a result of the executing of the business application.

At S310, a determination is made regarding which social media networks are accessible to the business application. In some aspects, one or more social media networks may not be accessible to the business application and/or users thereof, for one or more of a variety of reasons. For example, the business users may be prohibited or blocked from accessing or communicating with one or more of the social media networks using the business application. Accordingly, some embodiments herein may logically conclude that the prohibited or blocked social media networks need not be considered or communicated with regarding at least some of the operations of process 300.

At S315, the social media network(s) accessible by the business application may be queried in an effort to gather information related to the business data associated with the entity. That is, the appropriate social media network(s) may be queried to gather social media network data related to the entity. The querying of the social media network(s) for the social media network data associated with the entity may be based, at least in part, on the business data received from the business application.

In some aspects, the same business data associated with the business application related entity may be used as the basis for querying each of the one or more social media networks. As such, in some embodiments the search criteria for the querying of the one or more social media networks may not be modified or personalized for the individual social media networks. The social media networks may be queried at S315 for unique user identifiers of the respective social media networks based on the business data associated with the entity.

At operation S320, process 300 may proceed to determine a “true” user identifier for the entity on each of the social media networks queried (i.e., examined). As used herein, a “true” user identifier for the entity on each of the social media networks refers to the social media network identifier that correctly and accurately corresponds to the entity associated with the business data from the business application. In some aspects, the “true” identifier may be determined to be that social media network identifier that most closely corresponds to the entity.

In some aspects, operation S320 may determine the “true” identifier for the entity on each of the social media networks using techniques (e.g., algorithms) that may be individually customized for each of the queried social media networks. Thus, while the same business data associated with the business application related entity may be used as the basis for querying each of the one or more social media networks, the operation of determining the “true” identifier for the entity on each of the social media networks may vary for the different social media networks.

In some embodiments, operation S315 may provide more than one unique user identifier for any one of the social media networks. In some embodiments, operation S320 may operate to provide a single “true” identifier for each of the social networks. The specifics of the single “true” identifier for each social media network at operation S320 may include a plurality of considerations, analyses, weightings, calculations, etc.

Operation S325 may function to provide an output including the “true” identifier of the entity for each of the social media networks. In some embodiments, the output may comprise a report, a file or record, and any type of including a multimedia presentation, whether consumed immediately and/or stored and later consumed.

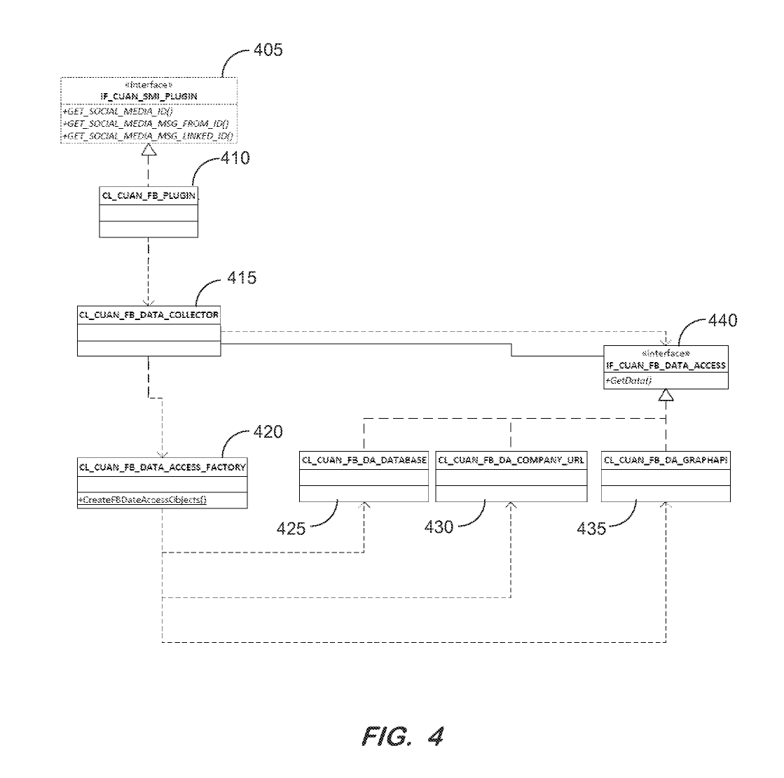

FIG. 4 is an illustrative depiction of some aspects herein. FIG. 4 is a representative view of a framework 400 supporting processes and systems disclosed herein to integrate a business application with aspects of social media networks. In particular, framework 400 illustrates a social media facade that has been customized to interface with a particular social media network. In the example of FIG. 4, the specific social media network indicated therein may be Facebook. However, it is noted that concepts and aspects illustrated by the example of FIG. 4 are not limited to any specific social media network, including those currently known and those that may become know in the future.

Framework 400 may include a number of classes 405-440 that represent abstractions of, for example, object oriented programming language objects. Interface plug-in class 405 interfaces with a business application (not shown) and is designed to, in part, get a “true” identifier for an entity related to the business application (i.e., “+GET_SOCAIL_MEDIA_ID( )”). Plug-in class 410 may encapsulate logic responsible for determining a “true” identity for the business application related entity. To facilitate the determination of the “true” identifier for an entity related to the business application, plug-in class 410 uses a data collector class 415 to collect data for the specific social media network. Data collector class 415 in turn uses a data access factory class 420 that creates and uses a plurality of data source objects 425, 430, and 435 to collect data associated with the social media network.

In the example of FIG. 4, three different potential sources of data related to the social media network are used, as represented by the classes 425, 430, and 435. For example, database class 425 may relate to the collection of social media network data from a database such as, for example a third-party database or service, a database match list and a service match list. Company URL class 425 may relate to the collection of social media network data from a URL corresponding to the entity related to the business application. An entity such as, for example, a business may have a company website that shares information about itself. In some aspects, the company website may reveal or at least suggest its correct identity on the social media network of FIG. 4. For example, in an effort to encourage others to “like” them on the social media network, the company's URL may encourage visitors to go to the social media network's and indicate they “like” the entity where the social media network of the user may be provided at the URL. Social network specific class 430 may relate to an API provided by the social media network itself (e.g., Facebook). Social network specific class 430 may function to allow a connection to the social media network. Upon connecting to the social media network, social network specific class 430 may retrieve a listing or other indication of the identifiers that may correspond to the entity.

In some aspects, personal data related to the entity and retrieved from the database (425), the company's own website (430), the social media network (435), and other sources not specifically included in n FIG. 3 may be retrieved by data access class 440. The results of the social media network data collection may be provided to data collector 415. Data collector 415 may operate to merge the results from the database (425), the company's own website (430), and the social media network (435). The merged results may be provided to the interface plug-in 410 that may operate to determine the “true” identify of the entity. In some aspects, interface plug-in 410 may contain the logic to determine the right or “true” identity of the entity for the social media network(s) based on the merged results and the business data regarding the entity as known by the business application.

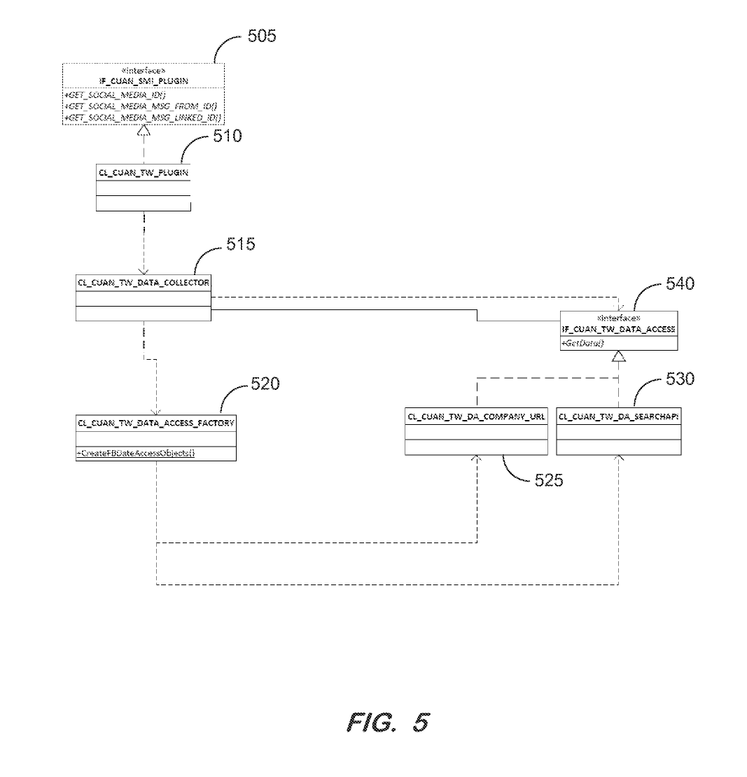

FIG. 5 may be similar in many respects to FIG. 4. In particular, classes 405-420 and 440 of FIG. 4 may in some ways correspond to classes 505-520 and 535 of FIG. 5, respectively. Accordingly, an understanding of FIG. 5 may in large part be understood by referencing the discussion of FIG. 4 above. One distinguishing aspect of FIG. 5 with respect to FIG. 4 is the inclusion of two sources of social media network identifiers, as opposed to the three sources disclosed in FIG. 4. This difference highlights, in part, the flexibility and expandability of the framework(s) disclosed herein.

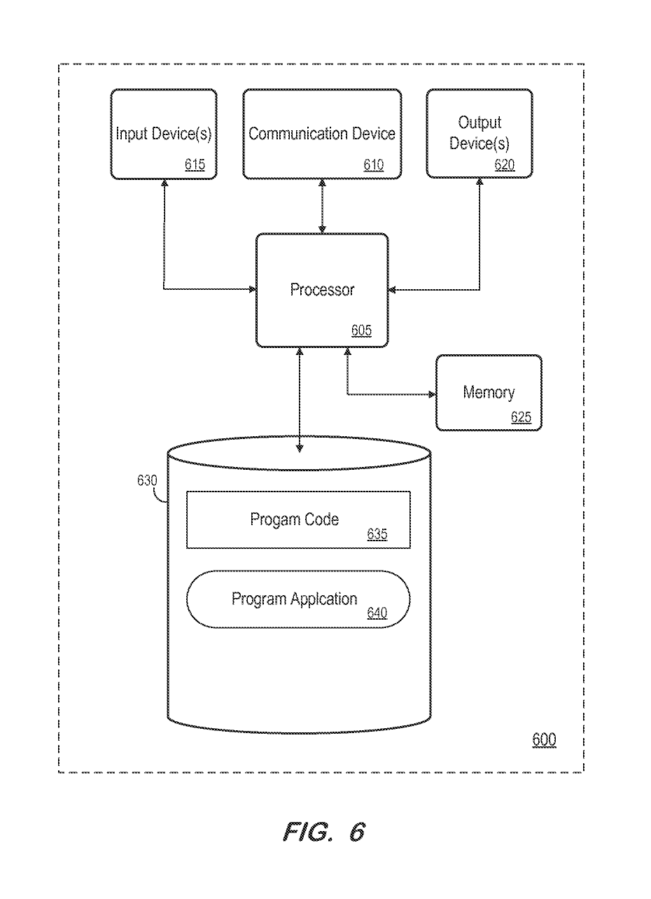

FIG. 6 is an illustrative block diagram of a system 600 that may be used to implement some embodiments herein. In some aspects, processes disclosed herein may be implemented, at least in part, by system 600. System 600 may comprise a general-purpose computing apparatus and may execute program code to perform any of the processes described herein, such as, but not limited to process 300. System 600 may include elements other than those specifically depicted in FIG. 6, according to some embodiments.

System 600 includes processor 605 operatively coupled to communication device 610, data storage device 630, one or more input devices 615, one or more output devices 620 and memory 625. Communication device 610 may facilitate communication with external devices and networks. Input device(s) 615 may comprise, for example, a keyboard, a keypad, a mouse or other pointing device, a microphone, knob or a switch, an infra-red (IR) port, a docking station, and/or a touch screen. Input device(s) 615 may be used, for example, to enter information into system 600. Output device(s) 620 may comprise, for example, a display (e.g., a display screen) a speaker, and/or a printer.

Data storage device 630 may comprise any appropriate persistent storage device, including combinations of magnetic storage devices (e.g., magnetic tape, hard disk drives and flash memory), optical storage devices, Read Only Memory (ROM) devices, etc., while memory 660 may comprise Random Access Memory (RAM).

Program code 635 of data storage device 630 may be executable by processor 605 to provide any of the processes described herein. In some embodiments, program code 635 may include for example, code of an operating system (OS). Embodiments are not limited to execution of these processes by a single apparatus. Application program 640 may include instructions that may be executed by processor 605. Data storage device 630 may also store data and other program code for providing additional functionality and/or which are necessary for operation thereof, such as device drivers, operating system files, etc.

Each system described herein may be implemented by any number of devices in communication via any number of other public and/or private networks. Two or more of the devices herein may be co-located, may be a single device, or may be located remote from one another and may communicate with one another via any known manner of network(s) and/or a dedicated connection. Moreover, each device may comprise any number of hardware and/or software elements suitable to provide the functions described herein as well as any other functions.

All systems and processes discussed herein may be embodied in program code stored on one or more computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

Embodiments have been described herein solely for the purpose of illustration. Persons skilled in the art will recognize from this description that embodiments are not limited to those described, but may be practiced with modifications and alterations limited only by the spirit and scope of the appended claims.

What is claimed is:

1. A computer-implemented method comprising:
receiving business data related to an entity from a business application;
determining, by a processor, at least one social media network to access by the business application;
querying the at least one social media network, based on search criteria derived from the business data, for unique identifiers of the at least one social media network associated with the entity;
determining, by the processor, a true identifier of the entity for the at least one social media network based on the unique identifiers and the business data; and
providing an output of the true identifier of the entity.

2. A method according to claim 1, wherein the business data is generated as a function of the business application.

3. The method of claim 1, wherein the receiving of the business data is performed automatically.

4. The method of claim 1, further comprising receiving an indication of the at least one social media network to access by the business application from the business application.

5. The method of claim 1, wherein the search criteria is the same for all of the at least one social media network.

6. The method of claim 5, wherein the determining of the true identifier of the entity comprises independently evaluating the unique identifiers and the business data for each of the at least one social media network.

7. The method of claim 1, further comprising interfacing with the least one social media network using an application interface mechanism specific for each of the at least one social media networks.

8. The method of claim 1, wherein the querying is further based on at least one of: a database match list, a service match list, an application match list, and a uniform resource locator associated with the entity.

9. A computer-readable medium storing program code, the medium comprising program code executable by a computer to:
receive business data related to an entity from a business application;
determine, by a processor, at least one social media network to access by the business application;
query the at least one social media network, based on search criteria derived from the business data, for unique identifiers of the at least one social media network associated with the entity;
determine, by the processor, a true identifier of the entity for the at least one social media network based on the unique identifiers and the business data; and
provide an output of the true identifier of the entity.

10. The medium of claim 9, wherein the business data is generated as a function of the business application.

11. The medium of claim 9, wherein the receiving of the business data is performed automatically.

12. The medium of claim 9, further comprising program code executable by a computer to receive an indication of the at least one social media network to access by the business application from the business application.

13. The medium of claim 9, wherein the search criteria is the same for all of the at least one social media network.

14. The medium of claim 13, wherein the determining of the true identifier of the entity comprises independently evaluating the unique identifiers and the business data for each of the at least one social media network.

15. The medium of claim 9, further comprising program code executable by a computer to interface with the least one social media network using an application interface mechanism specific for each of the at least one social media networks.

16. The medium of claim 9, wherein the querying is further based on at least one of: a database match list, a service match list, an application match list, and a uniform resource locator associated with the entity.

17. A system comprising:
a memory having program instructions stored thereon; and
a processor in communication with the memory, the processor being operative to:
receive business data related to an entity from a business application;
determine at least one social media network to access by the business application;
query the at least one social media network, based on search criteria derived from the business data, for unique identifiers of the at least one social media network associated with the entity;
determine a true identifier of the entity for the at least one social media network based on the unique identifiers and the business data; and
provide an output of the true identifier of the entity.

18. The system of claim 17, wherein the business data is generated as a function of the business application.

19. The system of claim 17, wherein the receiving of the business data is performed automatically.

20. The system of claim 17, further comprising the processor to execute program instructions to receive an indication of the at least one social media network to access by the business application from the business application.

21. The system of claim 17, wherein the search criteria is the same for all of the at least one social media network.

22. The system of claim 21, wherein the determining of the true identifier of the entity comprises independently evaluating the unique identifiers and the business data for each of the at least one social media network.

23. The system of claim 17, further comprising program code executable by a computer to interface with the least one social media network using an application interface mechanism specific for each of the at least one social media networks.

24. The system of claim 17, wherein the querying is further based on at least one of: a database match list, a service match list, an application match list, and a uniform resource locator associated with the entity.
